(19) United States
(12) Patent Application Publication
(10) Pub. No.: US 2012/0023454 A1
(43) Pub. Date: Jan. 26, 2012

(54) SCHEDULE MANAGEMENT USING LINKED EVENTS

(75) Inventor: Peter Pieruschka, Speyer (DE)

(73) Assignee: SAP AG, Walldorf (DE)

(21) Appl. No.: 12/839,758

(22) Filed: Jul. 20, 2010

(51) Int. Cl. G06F 9/46; G06F 3/048

(52) U.S. Cl. 715/853; 719/318; 718/100

(57) ABSTRACT

An event scheduler may schedule a first event having a first recurrence characteristic within a scheduling module, and to schedule a second event having a second recurrence characteristic within the scheduling module. A link manager may store a link between the first event and the second event within the scheduling module. A view generator may provide an event view which indicates the link in association with at least one of the first event and the second event.

### TECHNICAL FIELD

This description relates to schedule management.

### BACKGROUND

Conventional scheduling software enables users to schedule meetings, tasks, and other events, in a manner which assists users in easily remembering details about when and where such events will occur in the future, while avoiding the scheduling of different events within the same or overlapping timeframes. Further, such scheduling software enables easy collaboration between different users. For example, different employees of an organization may be facilitated in conducting meetings or other collaborations by sharing access to the same scheduling software. In another example, a manager may be facilitated in supervising tasks or schedules of employees, e.g., by viewing the scheduling software being used by each employee.

In many circumstances, a scheduled event may have a certain recurrence characteristic. For example, a scheduled meeting event may recur on a weekly or monthly basis. In another example, a manager may assign a task event to an employee, where the task is scheduled to be performed on a bi-weekly or bi-monthly basis. Conventional scheduling software generally enables scheduling of periodic recurrences of events, where the user may select from a variety of periods when organizing, updating, or otherwise scheduling a given event.

In typical scheduling scenarios, it may occur that each user within a group of users may need to schedule a relatively large number of events, each of which may potentially have the same or different periodicity as another one of the events. Further, various ones of the events may be related to one another in the context of a particular user or usage scenario, e.g., in a particular business context. For example, a given user may have two different events related to the performance of the same or similar task. In another example, different subgroups of a group of users may need to collaborate with one another to perform various subtasks of a larger task.

In such scenarios, each user must be aware of the various relationships between, and different characteristics of, the various related events. For example, if a user has a weekly event that is related to performance of a particular task, and a monthly event which is related to a performance review from a supervisor with respect to the task, then the user must remember the implicit relationship between the weekly event and the monthly event. However, given the relatively large number of scheduled events associated with each user, it may be difficult or inconvenient for the user to remember all such relationships between all such related events. Moreover, such difficulty or inconvenience may be increased further in situations in which it becomes necessary to alter or update one event of a related group of events.

Consequently, an addition to the difficulty and inconvenience of maintaining the various relationships between various events, a user may experience an actual decrease in performance of his or her duties. For example, the user executing a particular task at a particular time may fail to remember that the task is related to a different task which occurs at a later time, and therefore may not adequately prepare for the later of the two tasks. Thus, it may observed that conventional scheduling software does not adequately assist users in managing related events, and, in particular, does not adequately assist users in managing related events which have different characteristics or attributes.

### SUMMARY

According to one general aspect, a system may include instructions stored on a non-transitory computer readable medium and executable by at least one processor. The system may include an event scheduler configured to cause the at least one processor to schedule a first event having a first recurrence characteristic within a scheduling module, and to schedule a second event having a second recurrence characteristic within the scheduling module, a link manager configured to cause the at least one processor to store a link between the first event and the second event within the scheduling module, and a view generator configured to cause the at least one processor to provide an event view which indicates the link in association with at least one of the first event and the second event.

According to another general aspect, a method including executing instructions stored on a computer readable medium using at least one processor may include scheduling a first event having a first recurrence characteristic within a scheduling module, scheduling a second event having a second recurrence characteristic within the scheduling module, storing a link between the first event and the second event within the scheduling module, and providing an event view which indicates the link in association with at least one of the first event and the second event.

According to another general aspect, a computer program product including instructions stored on a non-transitory computer-readable medium may be configured to cause at least one processor to schedule a first event having a first recurrence characteristic within a scheduling module, schedule a second event having a second recurrence characteristic within the scheduling module, store a link between the first event and the second event within the scheduling module, and provide an event view which indicates the link in association with at least one of the first event and the second event.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for scheduling related events which have different attributes.

FIG. 2 is a flowchart illustrating example operations of the system of FIG. 1.

FIG. 3 is a screenshot that may be used in the system of FIG. 1.

FIG. 4 is a second screenshot which may be used in conjunction with the system of FIG. 1.

FIG. 5 is a screenshot illustrating an example view experience by a human processor of tasks created using techniques of FIGS. 3 and 4.

FIG. 6 is a screenshot illustrating additional or alternative views related to a set of related tasks.

### DETAILED DESCRIPTION

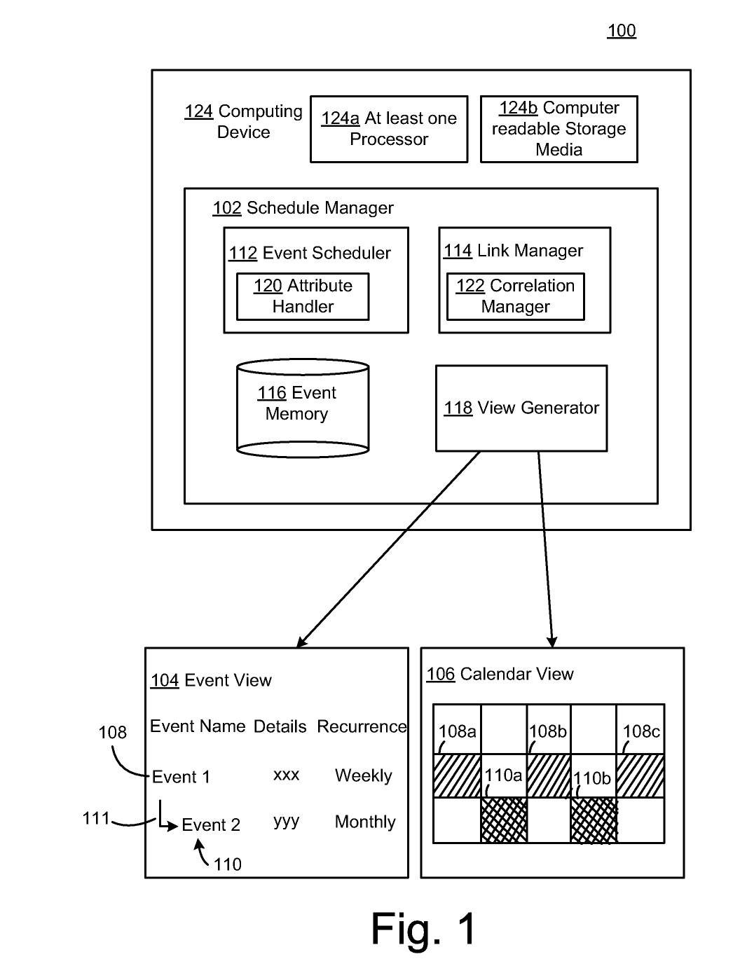

FIG. 1 is a block diagram of a system 100 for scheduling related events which have different attributes. In particular, the system 100 is configured to relate different events to one another in a manner which easily allows the user to remember the relationships there between, while allowing the user a large degree of flexibility in assigning or otherwise managing attributes of the different scheduled events which are related to one another. In this way, the user may therefore be enabled to easily view, and therefore remember, the various relationships between, and characteristics of, various associated events. Consequently, the user is better equipped to more easily and conveniently manage his or her schedule, and/or the schedule of another.

In the example of FIG. 1, a schedule manager 102 provides the above described functionality, and related functionality, by, for example, providing a link between two or more scheduled events which are related to one another. More particularly, the schedule manager 102 may provide an event view 104 which displays or otherwise provides an indication of each event, its characteristics, and its relationships to other events. In an additional or alternative embodiment, the schedule manager 102 may provide an alternative event view, e.g., a calendar view 106 which similarly displays or otherwise provides such indication(s) of event, characteristics thereof, and relationships there between.

For example, in the event view 104, a first event 108 is illustrated as having certain detailed characteristics, as well as an associated recurrence characteristic. Similarly, a second event 110 is illustrated as being displayed in conjunction with associated details of relevant characteristics or attributes, as well as a corresponding recurrence characteristic.

Of course, it may be appreciated that conventional scheduling software already contemplates, for events 108, 110, by themselves, many different types and characteristics, as would be apparent to one of skill in the art. For example, as referenced above, the event 108 and/or the event 110 may represent, for example, various types of meetings or other appointments of a user, or may represent tasks to be performed or supervised by the user. More generally, the events 108, 110 may represent virtually any occurrence or happening which a user may desire to schedule in the future, so that the events 108, 110 may therefore have virtually any associated number or type of characteristic or other attribute which may be associated therewith.

For example, the events 108, 110 may be associated with the same or different beginning and end dates, as well as various other attributes, such as, e.g., personnel or other users who may be associated with one or more occurrences or instances of the events 108, 110. In more specific examples, for example, when the events 108, 110 are associated with particular meetings in which the user may be involved, then event attributes may include a location of each meeting, as well as related information, e.g., resources available at each location, or directions to each location. Where the event 108, 110 refers to a remote conference, then attributes or other details of each event may include information to participate by telephone and/or over a network.

In other examples referenced herein, the events 108, 110 may relate to tasks to be performed by, or supervised by, the user. In such a case, details of each event 108, 110 may include information regarding descriptions of the task to be performed, performance metrics associated with performance of the task, resources which may be necessary or helpful in completing the task, or any other information which facilitates successful completion of the task in question.

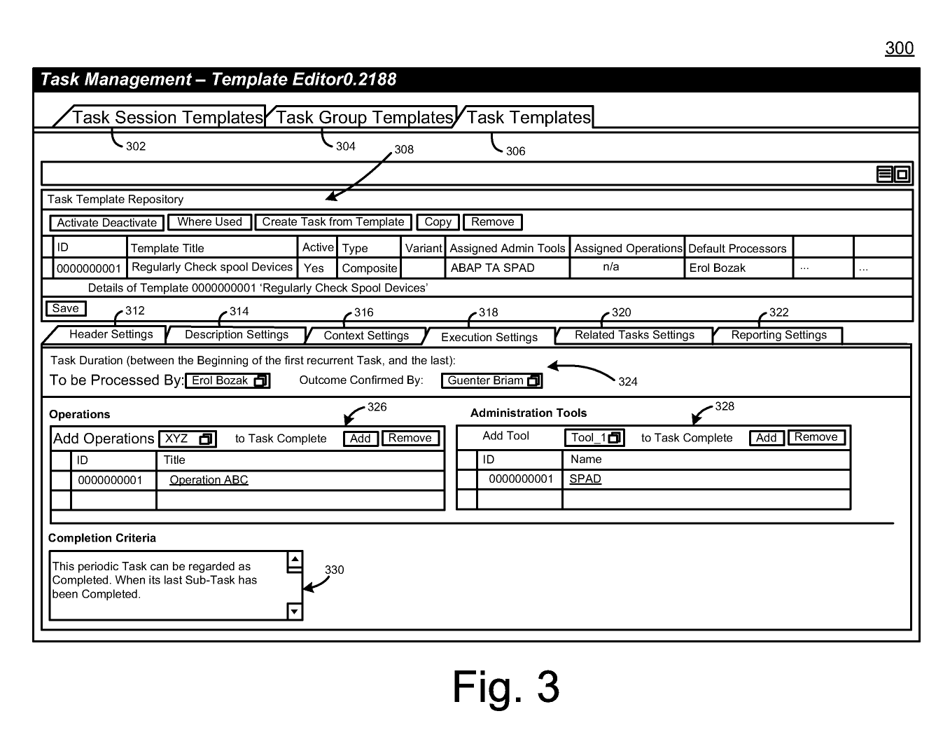

As referenced above, many other examples of the events 108, 110 would be apparent to one of skill in the art. Further, and similarly, details regarding specific implementations for displaying the views 104, 106 would also be apparent to one of skill in the art. For example, the event view 104 may present various events 108, 110 in a list view, a grid view, or any other suitable display format. Further, various known techniques may be used to display characteristics, attributes, or other details of each event 108, 110. For example, a name of each event 108, 110 may serve as a link to more specific information regarding each event 108, 110. In other examples, different tabs may be provided for use by the user in selecting a desired attribute of a given event to view in detail. Specific examples of such techniques are illustrated below with respect to the example screenshot of FIGS. 3-6. However, it will be appreciated that such examples are non-limiting, and are included merely for illustrative purposes, and that various other techniques and examples for displaying individual events 108, 110 would be apparent to one of skill in the art.

In the example of FIG. 1, the event view 104 is operable to illustrate, display, or otherwise provide, a relationship between the events 108, 110. Specifically, for example, in the event view 104, an arrow 111 is illustrated as a connector displaying a link between the event 108 and the event 110. For example, it may occur that the event 108 is related to a weekly task to be performed by the user, while the event 110 is related to a monthly meeting with a supervisor of the user regarding the task of the event 108. In this and similar cases, the event view 104 provides details regarding relationships between the event 108, 110, so that the user may be easily reminded of characteristics of such a relationship.

Moreover, the schedule manager 102 enables a decoupling of the various attributes of each of the events 108, 110 from one another, while maintaining the relationship there between, as referenced by the arrow 111. For example, in the example just given, the event 108 may be associated with attributes defining, e.g., co-workers or other collaborators of the user in actually executing the task, as well as resources which may be necessary or helpful in completing the task. Meanwhile, attributes of the event 110 may include an identification of the supervisor, as well as event attributes associated with conducting the meeting between the user and the supervisor.

Obviously, the attributes of the event 108 differs significantly from the attributes of the event 110. Nonetheless, the schedule manager 102 enables such separation between attributes of related event, and, e.g., enables the user to provide, update, or otherwise maintain such distinct attribute sets, while maintaining the relationship between the events 108, 110.

In particular, the schedule manager 102 enables the user to independently manage recurrent characteristics of the event 108 relative to the event 110. For example, it may occur that the event 110 (e.g., a meeting between the user and the user's supervisor) may need to be updated to occur on a bi-monthly basis, instead of a monthly basis. In this case, the schedule manager 102 permits the user to perform such a modification of the recurrent characteristic of the event 110, independently of the recurrent characteristic (e.g., weekly recurrence) of the related event 108, while nonetheless maintaining the relationship between the events 108, 110. In this way, the user may flexibly maintain the events 108, 110, as well as the relationships therebetween, while being explicitly made aware of the existence and nature of such a relationship.

As referenced above, and as illustrated in FIG. 1, the system 100 also may include a different type of event view, such as the calendar view 106 of FIG. 1. In general, such calendar views, and variations thereof, by themselves, are well known in the art to generally include a conventional calendar appearance which displays days of the week, months of the year, or other conventional calendar items. In the example of FIG. 1, the calendar view 106 explicitly illustrates specific event instances or occurrences 108A, 108B, 108C for the event 108, as well as event instances or occurrences 110A, 110B or the event 110.

That is, it may be appreciated that a given event may refer to an overall scheduled happening or other occurrence of a meeting, appointment, task, or other event. Thus, each such event will generally include specific event occurrences or instances. For example, if the event 110 is scheduled as having a monthly recurrence characteristic, as in the example of the event view 104, then specific event instances for the event 110 may occur, e.g., on the first day of the month for each of the 12 months of a particular designated calendar year.

In the example of FIG. 1, the calendar view 106 explicitly illustrates such instances 108A-108C, 110A, 110B. Of course, it may be appreciated that the event view 104 may similarly display specific event instances. For example, the event view 104 may provide specific event instances 108A-108C in response to a selection of the event 108 by the user. Various other known techniques for displaying individual event instances are known, and are not described here in detail except as may be necessary or helpful in understanding the operations of the system 100.

In the calendar view 106, the relationship between the event instances 108A-108C with the event instances 110A, 110B is illustrated or represented by the visual characteristic thereof. Such visual characteristics are conceptually illustrated in the example of FIG. 1 through the use of cross hatching being associated with all event instances 108A, 108B, 108C, 110A, 110B, but with distinct cross hatching being associated with the event instances 108A-108C, as compared to the illustrated cross hatching of the event instances 110A, 110B.

In other words, the relationship between the overall events 108, 110, as represented by the arrow 111 in the event view 104, may be represented or otherwise provided in the calendar view 106 by associating appropriate visual characteristics between the various event instances, and, in particular, by distinguishing visual characteristics of related events as compared to other scheduled events which are not related.

To give a specific, non-limiting example, it may be appreciated that a given user may have a large number of scheduled events displayed in (or associated with) the calendar view 104. In the example, the event instances 108A-108C and the event instances 110A, 110B all may be colored blue, while other, nonrelated events (or event instances) may be illustrated in a different color. In this way, it may be readily apparent to the user that the event instances 108A-108C and event instances 110A, 110B are related to one another, while not being related to various other scheduled events which may be illustrated within a calendar view 106.

Further, the relationship between the events 108 and 110 may be provided and utilized in various other ways, as well. For example, the user may click on the event instance 110A to thereby activate a link to one or more related events and/or event instances. In another example, the user may use a mouse cursor to hover over the event 110A, and thereby be provided with a pop up window or other display method in which some or all related events or event instances are illustrated. For example, by selecting the event instance 110A in these or similar manners, the user may be provided with related events and/or event instances which are occurring most closely in time with the event instance 110A.

In various embodiments, the event view 104 and the calendar view 106 may be used separately or in conjunction with one another. For example, the user may be provided with the event view 104, and may select an icon or other graphical user interface element in order to be provided with the calendar view 106, and vice versa. In other examples, the event view 104 may be provided with distinguishing visual characteristics that are described above with respect to the calendar view 104 (e.g., the events 108, 110 may be provided in a same or similar color as one another, and in a different color than other events which may be simultaneously displayed within the event view 104).

Thus, the user may easily utilize one or both of the event views 104, 106, in order to manage and benefit from various relationships between groups of events associated with the user, such as the events 108, 110. In this way, for example, the user may prepare for all such scheduled events in a more complete, efficient, and productive manner, with a minimal level of effort and difficulty/inconvenience. Moreover, the user may recognize such benefits while being provided with an ability to flexibly create, update, or otherwise maintain associated attributes of such groups of related events, or individual events or event instances thereof. Consequently, for example, a productivity of a user may be improved, and a profitability or other metric of success of the user, or an associated organization, may be increased.

In the specific example of the system 100 of FIG. 1, the schedule manager 102 includes an event scheduler 112 which may be configured to create, update, maintain, or otherwise schedule the events 108, 110 and other events associated with a user(s) of the schedule manager 102. For example, the event scheduler 112 may execute many or all of the various conventional functionalities of conventional scheduling software, such as e.g., associating an event and associated event instances with particular beginning and end dates, recurrence characteristics, and detailed attributes regarding exactly when and how various events will occur, including participants, locations, and resources needed to conduct each event.

For example, as in the example given above, the event scheduler 112 may designate, in examples related to the scheduling of meetings or other appointments, a specific time of day and length of, e.g., a meeting, as well as a location and participants of the meeting. In example scenarios related to task management, the event scheduler 112 may permit the assignment of a particular task to a particular user, while maintaining viewability of the task or the user for the supervisor or other assigning entity. Many other features associated with an operation with the event scheduler 112 may be understood to exist within conventional scheduling software, and therefore are not described herein in further detail, except as necessary or helpful to understand the operations of the system 100 of FIG. 1.

As multiple events are scheduled using the event scheduler 112, a link manager 114 may be configured to establish, maintain, or otherwise implement relationships between two or more of the scheduled events. In particular examples, the link manager 114 may coordinate with the event scheduler 112 to store linked events within an event memory 116. That is, the event memory 116 may be configured to store each event scheduled by the event scheduler 112, as well as to store relationships between various sets of two or more events which are desired to be related to one another.

In specific implementations, the event memory 116 may include a relational database, in which, for example, two related events such as the event 108, 110 may be related to one another within the event memory 116 using a common key. In other example implementations, the event memory 116 may represent an object-oriented memory, in which each event is stored as an object which includes various associated characteristics.

In examples of the latter, it may occur that a particular event is designated as a governing or master event, so that related events are considered to be sub-events thereof, and therefore stored within, or in association with, an object of the primary event. For example, event 108 may be stored using an associated event object, and may be considered to be a master event for a sub-event 110. In this case, the event 110 may be stored within the event object of the event 108, and thereby linked by the link manager 114 to the event 108. Various details associated with the implementation and use of the event memory 116 would be apparent to one of skill in the art, and therefore are not described here in further detail, except as may be necessary or helpful to understand the operations of the system 100 of FIG. 1.

Thus, in the schedule manager 102, a view generator 118 may be configured to read from the event memory 116 to produce event views 104, 106 which display or otherwise provide individual events, as well as relationships between the event and/or relationships between specific event instances thereof. For example, as described herein, the view generator 118 may generate the event view 104 which displays the event 108 and the event 110, and which displays the relationship there between graphically, using the arrow 111.

Of course, the arrow 111 may represent a conceptualization of an illustration of the relationship between the events 108, 110, and the view generator 118 may provide a demonstration of such relationship in a variety of different manners, some of which are described herein. For example, the events 108, 110 may be designated as being related simply by virtue of being displayed within a specific window or other display which is designated as including only related events. In other examples, the relationship between the events 108, 110 may be designated by providing active links from one event 108, 110 to the other. In still other examples, the relationship between the events 108, 110 may be provided by displaying a pop up window or other display that is associated with one of the events 108, 110 when the other event is selected or indicated by the user.

Of course, the view generator 118 may provide various other types of techniques for displaying the linked event(s), such as, e.g., the calendar view 106. As already described, the calendar view 106 may include various event instances 108A-108C, 110A, 110B which may be visually designated as being related to one another. In this way, a large number of sets of events may be included within the calendar view 106, yet the user may nonetheless be able to easily discern which displayed events are related to one another. For example, and in specific implementations, the user may be able to indicate a button or other selection icon associated with the calendar view 106, in order to select only a particular set of related events (e.g., the related events 108, 110), and to simultaneously filter out all nonrelated events from the calendar view 106. Of course, the user may thereafter select other related events (not shown in FIG. 1) for viewing with the calendar view 106, while filtering out and not displaying the related events 108, 110. In this way, the user may easily select and view only desired ones of those groups of events which are related to one another, as provided by the link manager 114.

As referenced above, by linking or otherwise relating events and event instances thereof, the schedule manager 102 may simultaneously decouple management of the various attributes associated with the linked events, so that such attributes may be maintained partially or wholly independently between related events and event instances. For example, as described herein, event attributes may include, for example, descriptions of participants, locations, or resources that may be associated with a given event. Consequently, as shown in FIG. 1, the event scheduler 112 may include an attribute handler 120 which may be configured to update or create such attributes for related events which are linked by the link manager 114, such that event attributes for different events of linked events may be maintained separately and independently from one another. Moreover, such event attributes may be maintained independently even for specific event instances associated with the particular event of a related set of two or more events.

For example, in the examples given above, the event 108 may relate to a task to be performed by a user, which may occur on a weekly basis, while the event 110 may relate to a monthly meeting that occurs between the user and the user's supervisor in order to review progress related to the task. In this case, the attribute handler 120 may be configured to ensure that attributes of the event 108 may be maintained independently of the attributes of the event 110, and, moreover, that attributes associated with specific event instances 108A-108C may be maintained independently from one another, and from attributes of the event instances 110A, 110B. For example, the attribute handler 120 may ensure that a location associated with the execution of the event instance 108A is appropriately different from a location associated with the event instance 110A. If necessary or desired, a location of the event instance 108B may be different than either location of the event instances 108A, 110A. Similarly, virtually all of the attributes associated with the various events 108, 110 (e.g., participants, resources, duration, or other event attributes) may be manipulated by the attribute handler 120 in a manner desired by any authorized user, while nonetheless maintaining the link relating the event 108 to the event 110.

One particular type of event attribute that may be governed by the attribute handler 120 relates to timing and other recurrent characteristics of the various events and event instances. For example, as described herein, a given event may have a certain recurrence characteristic, while the second, related event may have a separate recurrence characteristic. In the specific example given, the event 108 is described above as recurring weekly, while the event 110 is described as recurring monthly.

However, it may occur that the user may wish to update or modify any or all of the recurrence characteristics of a related event. For example, it may occur that the event 108 is designated as recurring weekly on Monday. However, it may be necessary to schedule the event instance 108B by itself for a different day of the week, e.g., Tuesday. In a further example, it may occur that particular ones of the event instances 108A-108C may need to be scheduled so as to recur on a bi-weekly basis, even though other event instances of the event 108 (not shown) may be desired to continue to occur on a weekly basis.

Meanwhile, the event 110 may similarly have different and changeable recurrence characteristics. For examples, in the examples described in which the event 110 occurs on a monthly basis, it may nonetheless occur that a particular day of the month associated with the event 110, or a particular event instance 110A, 110B thereof, may need to be altered by the user. In other examples, it may occur that particular subsets of event instance 110 may need to have different recurrence characteristics than the event 110 as a whole. For example, if the events 108, 110 are designated as having overall beginning and end dates associated with a first and last days of a calendar year, it may occur that within a given month, e.g., April, the event 110 may be desired to include multiple event instances, e.g., bi-weekly recurrence basis within a particular month, while maintaining the monthly characteristic of all the remaining instances of the event 110.

Thus, it may be observed the given event may have a wide variety of recurrence characteristics, which may change in whole or in part in a manner specified by the user. For example, the events 108, 110 may have recurrence characteristics in which, as described, specific event instances thereof occur on a periodic basis, with a frequency designated by the user when scheduling the event.

In other examples, however, the recurrence may be non-periodic, e.g., may occur on designated dates within a given timeframe, or within a different time period of a particular day, or whatever manner is desired by the user, and without necessarily being associated with a specific frequency of occurrence. For example, the user may simply designate that the event 108 has instances which occur on calendar days within a specific month that are simply selected by the user as having one or more event instances of the event 108.

In other examples, various combinations of the above examples may be implemented. For example, for a given event, certain subsets of event instances may occur with the first recurrence characteristic, e.g., a non-periodic occurrence, while other event instances may occur with a different recurrence characteristic, e.g., periodically. Still further, it may occur that a particular event recurs only once, i.e., has only a single event instance. Many other variations and combinations of such recurrence characteristics within and among events and event instances would be apparent to one of skill in the art. In any case, the attribute handler 120 may be configured to create, update, or otherwise maintain such recurrence characteristics for all desired events, independently of one another and of other event attributes, and independently of the relationship maintained between events by the link manager 114.

Many other types of conventional attributes also may be governed by the attribute handler 120, as would be apparent. For example, it may occur that certain authorization levels or other access requirements may be associated with a particular event or event instance, and/or a potential user or other viewer thereof. For example, some events may only be viewable by a supervisor, while other events are viewable by all users. In such cases, the attribute handler 120 may govern such event attributes for the particular events and users. Various other types of conventional event attributes also may be governed by the attribute handler 120, in a manner that, as described above, is independent of other associated event attributes, or of the relationship between events as maintained by the link manager 114.

In the examples described above, the link manager 114 is described as maintaining a link relationship between, e.g., the events 108, 110. More generally, however, it may be appreciated that the link manager 114 may implement a variety of types of relationships between events. That is, the link manager 114 may govern characteristics of particular relationships between linked events, in a manner desired by a user of the system 100.

For example, in FIG. 1, a correlation manager 122 is illustrated which may be configured to manage a correlation between the events 108, 110 in a specific manner desired by the user. For example, as referenced above, the event 110 may be considered to be a sub-event of the event 108, such that, for example, the event 110 may be required to be completed prior to completion of the event 108. For example, the event 108 may relate to a task to be performed by the user, while the event 110 may relate to a subtask of the task of the event 108. In this case, certain conditions for completion of the subtask 110 may be required before the task event 108 may be designated as having been completed.

In general, various priorities between related events may be designated in a desired manner. For example, a number of related events may be related to one another in a hierarchical fashion. In other examples, however, it may occur that events are related to one another as having an equal priority. For example, the event 108, 110 may simply refer to different meetings scheduled between different sub-groups of a group of employees, where no designated priority exists with respect to one meeting relative to another. In other examples, it may occur that the event 108 has certain beginning and end dates, while the event 110 has overlapping but different beginning and end dates. In such cases, the correlation manager 122 may designate that the events 108, 110 should be related during the overlapping period of time during which both events 108, 110 are active, or some designated portion thereof, while otherwise severing the relationship there between. Of course, many other types of correlations between events may be maintained by the correlation manager 122, as described herein in further detail or as would be apparent.

Although FIG. 1 is illustrated as including only two related events 108, 110, of course it may be appreciated that more than two events may be related, and that various techniques may be used in this regard. For example, multiple events may be linked in a parent-child relationship using a dedicated relational database table storing related identifiers. In these and other implementations, infinitely-nested, hierarchical structures may be created which permit a desired number of linked events to be related to one another in a desired manner.

In the example of FIG. 1, the schedule manager 102 is illustrated as executing on a computing device 124, which is itself illustrated as including at least one processor 124A, as well as computer readable storage media 124B. Thus, in some examples, it may occur that the schedule manager 102 executes using a single computing device, such as, e.g., a laptop or desktop computer of a user. Of course, the computing device 124 and these in other contexts may be networked, or otherwise connected to, or in communication with one or more computing devices, not specifically illustrated in the example of FIG. 1. For example, within a business or other organization, an internal network may be configured so that a user of the computing device 124 may exchange scheduling information, among many other types of shared information, within and among various other users of the business.

In further examples, some or all of the functionality of the schedule manager 102 may be executed on a server computer serving as the computing device 124, so that, e.g., one or more users at one or more corresponding client computers may be in communication with the computing device 124 acting as the server computer, so that, in various implementations, some or all of the schedule manager 102 may execute on the server computer, the corresponding client computers, or combinations thereof. Many other variations and configurations of computing devices, including the computing device 124, may be used to implement the schedule manager 102, as would be apparent to one of skill in the art.

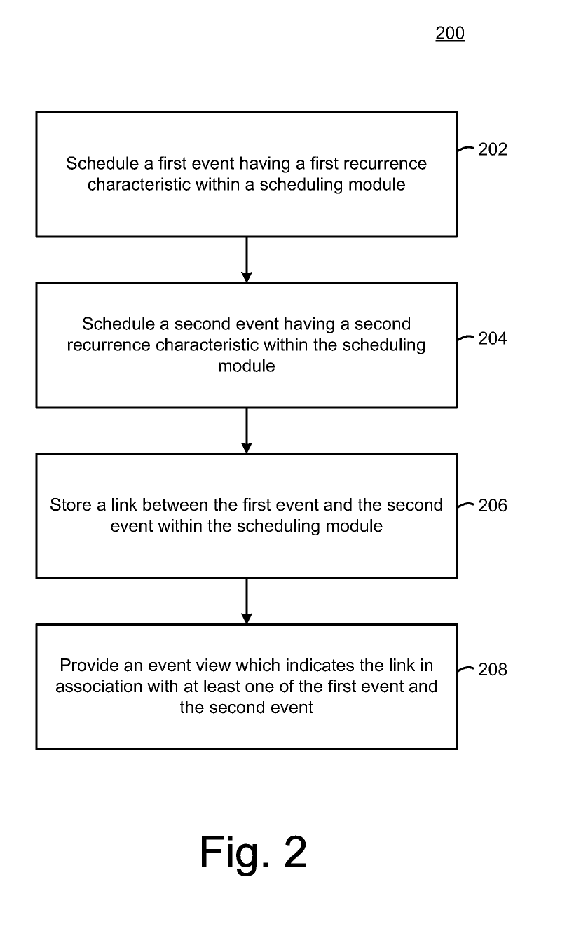

FIG. 2 is a flowchart 200 illustrating operations of the system 100 of FIG. 1. In the example of FIG. 2, operations 202-208 illustrate a sequential order of example operations that may be implemented by the system 100 of FIG. 1. It will be appreciated, however, that example of FIG. 2 is a non-limiting example, and that many additional or alternative implementations of the flowchart 200 may be implemented. For example, operations 202-208 of the flowchart 200 may be performed in a different order than that shown, and/or may be performed partially or wholly in an overlapping or parallel manner.

In the example of FIG. 2, a first event having a first recurrence characteristic may be scheduled within a scheduling module (202). For example, the event scheduler 112 may be configured to schedule the event 108 within software associated with the schedule manager 102. As referenced above, the event 108 may include various event instances e.g., 108A-108C, may be associated with various event attributes, may be associated with specified beginning and end dates, and may have associated therewith a particular recurrence characteristic of the various event instances 108A-108C. For example, as described, such event instances may be designated as recurring in a periodic manner having a specified, associated frequency, such as e.g., daily, weekly, or monthly, or virtually any desired periodicity. Other non-periodic recurrence characteristics also may be included. For example, the event 108 may include event instance subsets associated with the first periodicity, while other event instance subsets are associated with a different periodicity. In still other examples, the recurrence characteristic of the event 108 may be completely non-periodic, such as when the user simply designates desired days on which scheduled event instances are desired to occur.

A second event having a second recurrence characteristic may also be scheduled within the scheduling module (204). For example, the event scheduler 112 may be configured to schedule the event 110 within software associated with the schedule manager 102, in much the same way as just described above with respect to the event 108. That is, it may be appreciated that the event 110 may generally have, or be associated with, any or all of the various options or aspects just described above with respect to event 108, and that an authorized user may select any combination or subset thereof when scheduling the event 110.

A link between the first event and the second event may be stored within the scheduling module (206). For example, the link manager 114 may store a link between the event 108 and the event 110, e.g., using the event memory 116. It may be appreciated, as referenced above, that an order of the operations 202-206 need not be strictly sequential. For example, it may occur that the events 108, 110 are scheduled essentially at the same time, and that linking there between may occur at essentially the same time, or thereafter. In other examples, it may occur that the event 108 is scheduled a first time, and that the event 110 is not scheduled until some much later time. For example, a user may schedule the event 108 as recurring on a weekly basis in association with a specific task. After some number of weeks pass, the user may be instructed to schedule an associated meeting with the user's supervisor to discuss the task associated with the event 108. In this case, at that time, the user may schedule the event 110 as being associated with the monthly meeting with the user's supervisor, and linking of the event 108, 110 may occur at a time of creation of the event 110, or at a later date, as desired by the user.

Various other aspects and characteristics of linking between events 108, 110 are referenced herein. For example, the linking may be executed so as to include or represent a hierarchical relationship between the events 108, 110. In other examples, the events 108, 110 may not be nested or subsumed within one another in any particular manner, but, rather, may simply be linked as otherwise independent tasks or other events, which are desired to be related by the user.

An event view which indicates the link in association with at least one of the first event and the second event may be provided (208). For example, the view generator 118 may provide the event view 104, which, as described above, may be configured to indicate the relationship or other link between the events 108, 110, e.g., in a visual or graphical manner within the event view 104. For example, as described, the view generator 118 may indicate a relationship between the events 108, 110 in a variety of manners, e.g., by including the arrow 111 or other connector indicating a link there between, or by including both of the events 108, 110 within a common frame or other sub portion or view of the event view 104, or by otherwise including some visual indication of relatedness of the events 108, 110.

In various other examples described herein, the view generator 118 may additionally or alternatively include an event view which includes the calendar view 106. As generally described, the calendar view 106 may include specific event instances 108A-108C, 110A, 110B, which may be presented visually in a manner which displays or otherwise indicates the relationship of the link there between. As described, the calendar view 106 happens to include event instances from both of the events 108, 110 in the example of FIG. 1. However, it may be appreciated that, in a given view, it may occur that only event instances of a particular event happen to be visible within a calendar view at a given time. In such cases, the view generator 118 may nonetheless provide visual indication of relatedness of the displayed event or event instance within the calendar view, e.g., by highlighting, emphasizing, coloring, or otherwise visually indicating relatedness of a particular event or event instance to at least one other event or event instance. Further, it will be appreciated that the user may toggle between or otherwise select viewings of the event view 104 as compared to the calendar view 106, combinations thereof, or other types of event views not specifically illustrated in FIG. 1.

Thus, the systems and operations of FIGS. 1 and 2 provide for a number of features and advantages over conventional scheduling software. For example, as described, the systems and methods of FIGS. 1 and 2 provide for easy addition, deletion, or modification of individual recurrent events that in some way differ from a remainder of related recurrent events. Further, the systems and methods allow for use and management of events having combined periodicity in which, e.g., an executive process that occurs weekly is mixed with a controlling process that is required monthly while both refer to the same business context.

Further, the described systems and methods provide for decoupling of event attributes of individual events (or event instances) relative to event attributes of an entirety of an event set. For example, a manager or supervisor may be in charge of all of a set of events, whereas different employees may be assigned only to individual events or subsets of events. Thus, e.g., due to the described decoupling of events from associated event attributes and characteristics, the described systems and methods of FIGS. 1 and 2 provide for creation of any combination of event periodicities or other recurrent characteristics, flexible modification of individual events or event sets or subsets, and flexible modification of event attributes, thereby supporting usage scenarios which are very common in business and other contexts.

FIG. 3 is a screenshot 300 that may be used in the system 100 of FIG. 1. More specifically, the screenshot 300 may be related to an example implementation scenario in which the scheduled events of the system 100 include tasks to be assigned to, and performed by, task processors or other users within an organization.

In the example of FIG. 3, it is assumed that tasks may be created and assigned using a repository of pre-established task templates. That is, each task that may be assigned by a supervisor to a processor of the task may be stored as a template, e.g., within the event memory 116 within other suitable memory. Then, at a time of assignment of a given task, a supervisor or other assigned party may select a desired task template from the appropriate memory, and may configure the task template as needed for assignment to a particular processing user.

Thus, in the example of FIG. 3, a template editor is shown within the screenshot 300 as including a number of available tabs 302-306 for use in configuring and assigning tasks. Specifically, a task session template tab 302 may permit supervisors or other assigning parties to access templates associated with an overall task session. For example, such a task session may include session attributes which govern, or related to, an overall context in which one or more tasks to be performed. For example, such session information may include, or reference, organizational entities or sub-entities may be involved with the task performance, individuals or groups of potential users who may execute the task, in various other general resources or attributes which may potentially be related to, or included in, performance of the task to be created and assigned.

A second tab 304 allows assigning users to access templates related to a group of tasks. For example, an assigning user may be able to create and configure task groups within a specific task session, where a given group of tasks share the same or similar attributes. Thus, in general, it may be appreciated that the task session templates and the task group templates generally represent techniques for providing efficiency to users in assigning and creating tasks, e.g., because such task sessions and task groups enable users to configure task sessions and task groups to a certain extent only a single time, without having to repeat such configuration information for each individual task.

Further in FIG. 3, a task template tab 306 is illustrated which provides for editing, configuration, and assigning of a particular task. In the example of FIG. 3, the task template tab 306 is selected as being activated for current use.

Within the task template tab 306, a portion 308 illustrates available task templates from a task template repository, as referenced above. As shown, the portion 308 may include various elements related to accessing or otherwise using task templates from the task template repository. For example, as shown, a portion 308 may enable a user to activate or deactivate a given task template, to determine where and how a given task template or associated task may be used, to create a specific task or task instance from a given task template, or to copy or remove a task template from the repository.

Further in the portion 308, various templates may be included, although for the sake of simplicity and conciseness, only a single task template is illustrated in the example of FIG. 3. Specifically, as shown, a template associated with a task of regularly checking spool devices is illustrated. As shown, various information about such task templates may be included in the portion 308, e.g., an ID number of a template, title of a template, a status of the template as being active or inactive, a type or variation of a template associated tools, operations, or other resources that may be associated with performance of the task, and identification of a human processor in charge of executing the task.

Further within the task template tab 306, a portion 310 may be used to view and define details related to a selected task template from the portion 308. As shown, and similarly to the portion 308, the portion 310 may include various tabs 312-322 which enable a user to select various particular aspects of the selected task template for configuration.

As shown, the tab 312 enables the user to input header settings for the task template, while the tab 314 enables inputs of a detailed description regarding the task. The tab 316 enables context settings associated with the task, while a tab 318 enables specific execution settings associated with the task. A tab 320 may be used to configure related tasks that are linked to the selected task shown within the portion 310, and the tab 322 may be associated with details regarding whether, when, and how reporting must be performed with respect to the task in question.

In the example of FIG. 3, the tab 318 associated with defining execution settings for the task is shown as being selected. Within the tab 318, a portion 324 is illustrated as enabling a user to assign a task duration, e.g., a setting of beginning and end date for the task. The portion 324 further enables a selection of the human processor of the tabs, as well as a separate human user (e.g., supervisor), who may be responsible for confirming an outcome of the task. Meanwhile, a portion 326 allows addition of a specific operation into the task template in question, while a portion 328 allows the user to identify certain administration tools which may be useful as resources in completing the task in question. Finally in FIG. 3, a window 330 enables the user to input completion criteria which defines whether, when, and how the task in question may be considered to be completed. In the example of FIG. 3, as shown, the completion criteria of window 330 is illustrated as specifying that the particular task in question may only be regarded as completed once its last subtask has also been completed.

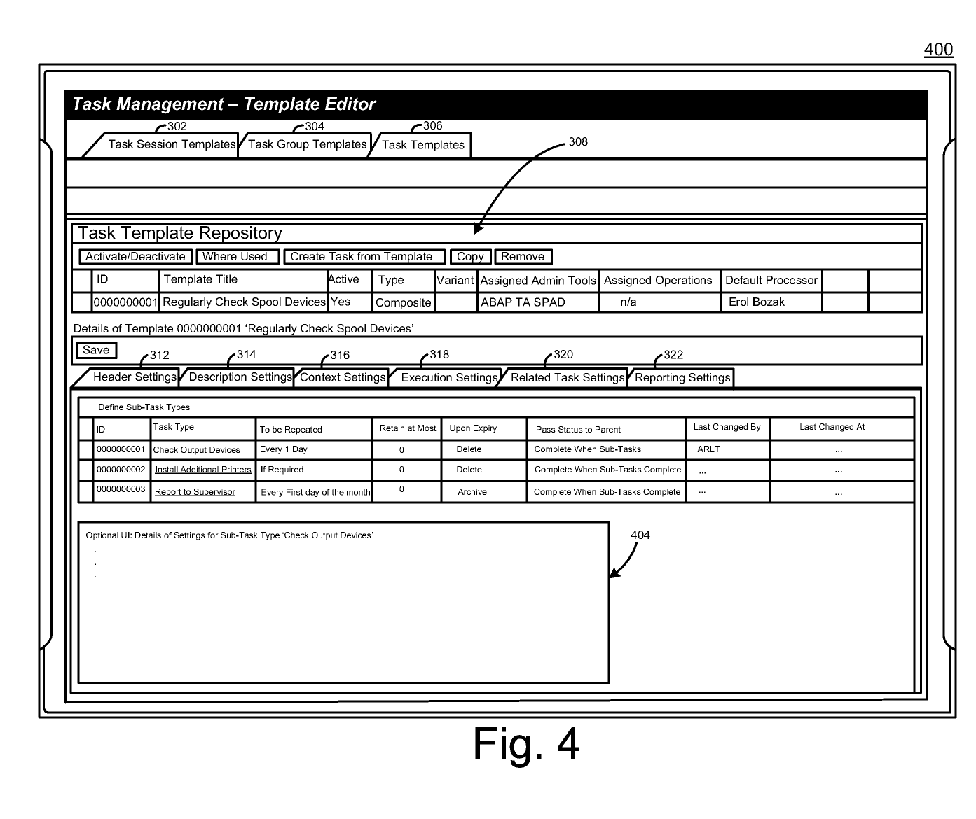

FIG. 4 is a second screenshot 400 which may be used in conjunction with the system 100 of FIG. 1. More specifically, the screenshot 400 illustrates a variation of the screenshot 300 in which the tab 320 associated with the related task settings has been selected by the user. As shown, within the tab 320, a portion 402 may be associated with definition of subtask types that may be related to the task input selected from the portion 308. As shown, the portion 402 may thus include, e.g., identification numbers for a given task or task types, recurrence characteristics about when the subtask should be repeated, as well as comparison information about a retention, expiration, status, or most recent change information associated with each specific subtask. Also in FIG. 4, a portion 404 may include a sub portion which enables the viewing of details and settings for a specific subtask or subtask types which are selected from the portion 402.

Thus, it may be observed that the examples of FIGS. 3 and 4 illustrate specific examples of the system 100 of FIG. 1, in which the scheduled events are associated with tasks, and in which the various task templates may be used to configure such tasks, which thus may be considered analogous to the events 108, 110. Consequently, relation of the task to one another, e.g., as shown in the tab 320 or related task settings may be considered to be representative of a linking or other relation of tasks to various subtasks, e.g., by the link manager 114.

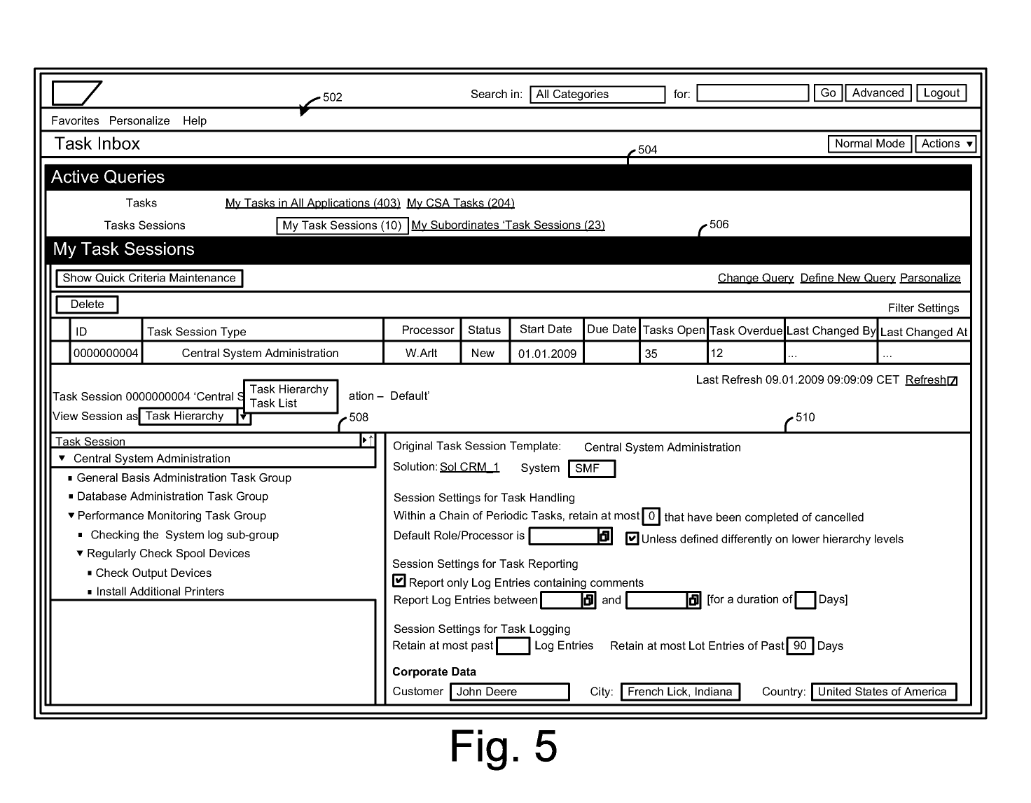

As described above, FIGS. 3 and 4 thus represent an implementation example in which tasks are designed, created, and ultimately assigned to users for performance thereof. FIG. 5 is a screenshot 500 illustrating an example view experience by a human processor of tasks created using techniques of FIGS. 3 and 4. That is, the screenshot 500 is associated with a runtime or execution aspect of one or more tasks associated with a human task processor.

Thus, in the example of FIG. 5, a task inbox 502 may be associated with, and viewed by, a human task processor, and may be configured or otherwise used by the human processor to select, view, search for, configure, or otherwise access or use information about assigned tasks, so as to complete execution thereof. Within a task inbox, a portion 504 includes various tasks and task sessions associated with a given user, or subordinates of that user. Specific tasks may be associated with applications or sessions, or otherwise partitioned for a desired level or type of viewing by the user.

A portion 506 includes a view of a selection from the portion 504. For example, as shown, the user's task sessions may be selected within the portion 504 for viewing within the portion 506. Consequently, the portion 506 includes one or more selected task sessions, and thus includes various identification information regarding the selected task sessions, including identification of a human processor, various status data associated therewith, and other tools and information which may be used to configure or use a particular selected task session.

A portion 508 enables further viewing of a selected specific task session, while a portion 510 allows viewing of details about a selected task session from the portion 508. In the specific example of FIG. 5, the portion 508 illustrates that tasks may be viewed within a session in either a hierarchical or list form, and that, in the example of FIG. 5, the hierarchical view has been selected. Consequently, an overall task session related to central system administration (CSA), is illustrated as including various sub task sessions.

As shown, the portion 508 may thus include various sub sessions or tasks which are related to the highest level CSA task session, including, as shown, various administration or monitoring tasks, where the latter group may include the checking of spool devices which may relate to tasks defined in the examples of FIGS. 3 and 4, above.

In the portion 510, the user selected the top level CSA task session for viewing therein. As shown, the portion 510 may include information about original task session templates for the task session, as well as various session settings for handling the associated task, e.g., retention characteristics of or for completed or canceled tasks, as well as information about default human processors for the task. Portion 510 may further include session settings for definition of reporting characteristics associated with the tasks, such as whether, when, and how to report information about execution or completion of the task in question. Similarly, session settings may be made for whether, when, and how task logging may occur, including retention information related to task log entries. Further, the portion 510 may include data related to a corporation or other customer associated with the task to be performed.

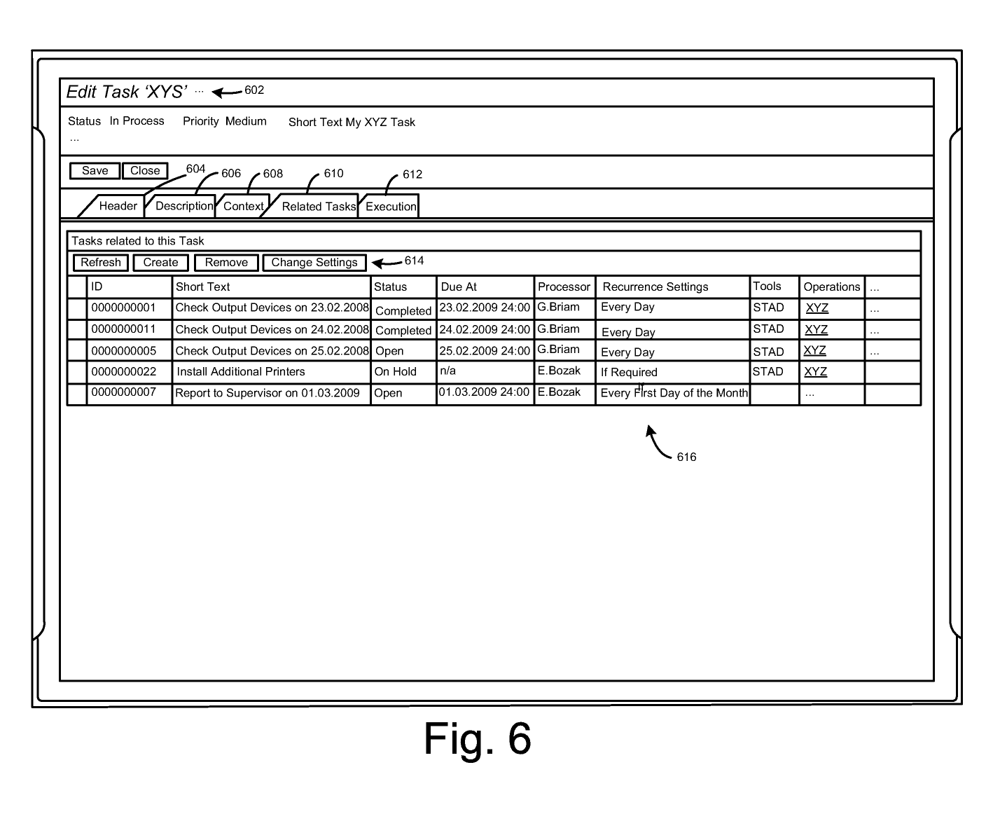

FIG. 6 is a screenshot 600 illustrating additional or alternative views related to a set of related tasks. In the example of FIG. 6, the screenshot 600 may thus represent a view experienced by either or both of an assigning or executing user of the system 100 to view a set of related tasks.

That is, as shown, the screenshot 600 is related to a specific task “XYZ,” which has been selecting for viewing, and which includes a portion 602 that includes various high level information regarding the task, such as, for example, a current status, priority, or short description thereof.

Similar to the examples above, a plurality of tabs 604-612 may be included which enable the user to select various characteristics or aspects of the task in question. As shown, a tab 604 may be related to header information for the task, while a tab 606 includes more detailed description of the task. A tab 608 may be used to provide context information associated with the task, while the tab 610 illustrates related tasks of a task of the screenshot 600. Finally, a tab 612 may be used to view specific execution information regarding past, present, or future execution of the task in question.

In the example of FIG. 6, the tab 610 illustrates related tasks which have been selected for viewing. As shown, the tab 610 may include a portion 614 which provides various buttons, icons, or other widgets which enable a viewer of the screenshot 600, if authorized, to perform various actions related to the related tasks, including, for example, a refresh of a list of the tasks, a creation or removal of a particular task, and alteration of settings associated with a particular task.

Finally in FIG. 6, a portion 616 includes an actual listing of the related tasks that are linked to the task “XYZ” of FIG. 6. Similarly to the above examples, and as shown in FIG. 6, the portion 616 may include a listing of the related tasks, as well as identification information related thereto, associated status information, due dates, human processors, recurrence characteristics, and resources associated with performance thereof.

Thus, the example screenshots of FIGS. 3-6 illustrate various specific example implementations of the systems and methods of FIGS. 1-2. Of course, it may be appreciated that various alternative implementations may exist. For example, it may be observed that screenshot 600 of FIG. 6 may correspond to the event view 104 of the system 100 of FIG. 1, and that screenshot 600 illustrates various event names, details, and recurrence characteristics, for a related event, (e.g., task).

Consequently, it may be appreciated from the above description that a corresponding calendar view for the screenshot 600 of FIG. 6 also may be provided, which would thus be analogous to the calendar 106 of FIG. 1. More generally, it may be appreciated that many various elements or attributes of the system 100 of FIG. 1 may be implemented in the context of the screenshots of FIGS. 3-6, or in similar context. Thus, it may be observed that the system 100 of FIG. 1 provides for a wide range of settings in which events may be scheduled and executed in a manner which is efficient, in which enhances a productivity of the users thereof.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A system including instructions stored on a non-transitory computer readable medium and executable by at least one processor, the system comprising:
an event scheduler configured to cause the at least one processor to schedule a first event having a first recurrence characteristic within a scheduling module, and to schedule a second event having a second recurrence characteristic within the scheduling module;
a link manager configured to cause the at least one processor to store a link between the first event and the second event within the scheduling module; and
a view generator configured to cause the at least one processor to provide an event view which indicates the link in association with at least one of the first event and the second event.

2. The system of claim 1 wherein the first recurrence characteristic includes a first periodicity.

3. The system of claim 2 wherein the second recurrence characteristic includes a second periodicity that is different from the first periodicity.

4. The system of claim 1 wherein the event scheduler includes an attribute handler configured to cause the at least one processor to associate first event attributes with the first event, independently of associating second event attributes with the second event.

5. The system of claim 4 wherein the first event attributes and the second event attributes include the first recurrence characteristic and the second recurrence characteristic, respectively.

6. The system of claim 1 wherein the link manager includes a correlation manager configured to cause the at least one processor to characterize a nature of the link.

7. The system of claim 6 wherein the correlation manager is configured to characterize the link as representing a hierarchical relationship between the first event and the second event.

8. The system of claim 1 wherein at least one of the first event and the second event includes a scheduled meeting.

9. The system of claim 1 wherein at least one of the first event and the second event includes a task to be performed.

10. The system of claim 9 wherein the first event and the second event include a first task and a second task, respectively, and wherein the link manager includes a correlation manager configured to cause the at least one processor to characterize a nature of the link, including a requirement that the second task be competed prior to completion of the first task.

11. The system of claim 1 wherein the view generator is configured to provide the event view and indicate the link including grouping the first event and the second event within a single view of the event view.

12. The system of claim 1 wherein the view generator is configured to provide the event view and indicate the link including displaying a connector between the first event and the second event.

13. The system of claim 1 wherein the view generator is configured to provide the event view including a calendar view in which first and second event instances of the first and second events, respectively, are displayed, and wherein the first and second event instances are associated with a common visual characteristic to indicate the link.

14. A method including executing instructions stored on a computer readable medium using at least one processor, the method comprising:
scheduling a first event having a first recurrence characteristic within a scheduling module;
scheduling a second event having a second recurrence characteristic within the scheduling module;
storing a link between the first event and the second event within the scheduling module; and
providing an event view which indicates the link in association with at least one of the first event and the second event.

15. The method of claim 14 wherein the first recurrence characteristic includes a first periodicity, and the second recurrence characteristic includes a second periodicity that is different from the first periodicity.

16. The method of claim 14 wherein providing the event view includes indicating the link including grouping the first event and the second event within a single view of the event view.

17. The method of claim 14 wherein providing the event view includes providing a calendar view in which first and second event instances of the first and second events, respectively, are displayed, and wherein the first and second event instances are associated with a common visual characteristic to indicate the link.

18. A computer program product including instructions stored on a non-transitory computer-readable medium and configured to cause at least one processor to:
schedule a first event having a first recurrence characteristic within a scheduling module;
schedule a second event having a second recurrence characteristic within the scheduling module;
store a link between the first event and the second event within the scheduling module; and
provide an event view which indicates the link in association with at least one of the first event and the second event.

19. The computer program product of claim 18, wherein the first recurrence characteristic includes a first periodicity, and the second recurrence characteristic includes a second periodicity that is different from the first periodicity.

20. The computer program product of claim 18, wherein at least one first event attribute is associated with the first event, independently of at least one second event attribute associated with the second event, and wherein the at least one first event attribute and the at leas one second event attribute include the first recurrence characteristic and the second recurrence characteristic, respectively.
